(19) United States
(12) Patent Application Publication
(10) Pub. No.: US 2013/0027841 A1
(43) Pub. Date: Jan. 31, 2013

(54) MULTI-LAYERED CERAMIC CAPACITOR

(71) Applicant: Kwang Chun Jung, Suwon (KR)

(72) Inventor: Kwang Chun Jung, Suwon (KR)

(73) Assignee: SAMSUNG ELECTRO-MECHANICS CO., LTD.

(21) Appl. No.: 13/303,968

(22) Filed: Nov. 23, 2011

(30) Foreign Application Priority Data
Jul. 26, 2011 (KR) 10-2011-0074041

(51) Int. Cl. H01G 4/12

(52) U.S. Cl. 361/321.2

(57) ABSTRACT

There is provided a multi-layered ceramic capacitor including: a laminated body having a plurality of dielectric layers laminated therein and including first and second surfaces opposed to each other; a first internal electrode formed between the plurality of dielectric layers, exposed to the first surface, and including a plurality of first sub-electrodes; a second internal electrode exposed to the second surface and including a plurality of second sub-electrodes alternately disposed with the first sub-electrodes; a third internal electrode having at least one dielectric layer disposed between the first and second internal electrodes and the third internal electrode, exposed to the second surface, and including a plurality of third sub-electrodes disposed to be opposed to the first sub-electrodes; and a fourth internal electrode exposed to the first surface and including a plurality of fourth sub-electrodes opposed to the second sub-electrodes and alternately disposed with the third sub-electrodes.

### CROSS-REFERENCE TO RELATED APPLICATIONS

This application claims the priority of Korean Patent Application No. 10-2011-0074041 filed on Jul. 26, 2011, in the Korean Intellectual Property Office, the disclosure of which is incorporated herein by reference.

### BACKGROUND OF THE INVENTION

1. Field of the Invention

The present invention relates to a multi-layered ceramic capacitor, and more particularly, to a multi-layered ceramic capacitor appropriate for high capacitance and miniaturization.

2. Description of the Related Art

In accordance with the miniaturization and integration of electronic products, the demand for the miniaturization and slimming of passive elements has also increased. Particularly, in accordance with the development of communications apparatuses based around cellular phones, the demand for a multi-layered ceramic capacitor (MLCC) has rapidly increased. Therefore, research into the multi-layered ceramic capacitor according to the miniaturization thereof has been variously conducted.

The multi-layered ceramic capacitor according to the related art has been manufactured through a method in which internal electrodes are formed and laminated on a ceramic layer. This product, which is a capacitor for a surface mounted device (SMD), has been currently applied to almost all products.

The multi-layered ceramic capacitor has been used in wide band of capacitance ranging from several pFs to several tens of μFs.

The capacitance of a general capacitor may be represented by the following Equation.

$$C = \frac{ɛ A}{d}$$

As a method for increasing the capacitance of the general capacitor, there are three methods. A first method is to use a material having a high permittivity ∈ as a dielectric, while a second method is to reduce a distance d between electrodes, and a third method is to increase an area A of an electrode.

Particularly, in accordance with the requirement for high capacitance and miniaturization, research into a method of increasing the capacitance of a capacitor by developing a high-k dielectric substance or a method of changing a capacitor structure for increasing capacitance while using the same dielectric substance therefor and retaining the physical size thereof, has been recently conducted.

### SUMMARY OF THE INVENTION

An aspect of the present invention provides a multi-layered ceramic capacitor capable of having a minimized size while having maximized capacitance by optimizing a structure thereof.

Another aspect of the present invention provides a multi-layered ceramic capacitor capable of optimizing a Q value by decreasing an equivalent series resistance (ESR) value through a minimization of a resistance value of an internal electrode, while increasing capacitance.

According to an aspect of the present invention, there is provided a multi-layered ceramic capacitor including: a laminated body having a plurality of dielectric layers laminated therein and including first and second surfaces opposed to each other; a first internal electrode formed between the plurality of dielectric layers, exposed to the first surface, and including a plurality of first sub-electrodes; a second internal electrode exposed to the second surface and including a plurality of second sub-electrodes alternately disposed with the first sub-electrodes; a third internal electrode having at least one dielectric layer disposed between the first and second internal electrodes and the third internal electrode, exposed to the second surface, and including a plurality of third sub-electrodes disposed to be opposed to the first sub-electrodes; and a fourth internal electrode exposed to the first surface and including a plurality of fourth sub-electrodes opposed to the second sub-electrodes and alternately disposed with the third sub-electrodes.

The first and second internal electrodes or the third and fourth internal electrodes may have a comb shape and be disposed to be engaged with each other within the same dielectric layer.

Any one sub-electrode selected from a group consisting of the first to fourth sub-electrodes may include: one active area defined in relation to a sub-electrode disposed to be opposed to any one sub-electrode, while having the at least one dielectric layer therebetween; and another active area defined in relation to a sub-electrode disposed to be engaged with any one sub-electrode.

The first and second internal electrodes may include: a first active area formed between the first and second sub-electrodes; a second active area formed between the first and third sub-electrodes; a third active area formed between the second and fourth sub-electrodes; and a fourth active area formed between the third and fourth sub-electrodes.

Each of the plurality of the first, second, third, fourth sub-electrodes may be connected to each other by a single lead part and exposed to the first or second surface.

Each of the first, second, third, fourth sub-electrodes may have a rectangular shape.

Each of the first, second, third, fourth sub-electrodes may have a trapezoidal shape.

A distance between the first and third internal electrodes formed in different layers, or a distance between the second and fourth internal electrodes formed in different layers, may be adjusted to thereby adjust capacitance.

A distance between the first and second sub-electrodes formed in the same dielectric layer or a distance between the third and fourth sub-electrodes formed in the same dielectric layer may be adjusted to thereby adjust capacitance.

At least one sub-electrode selected from a group consisting of the first to fourth sub-electrodes may include a free end and an exposed end, and a ratio of a width of the free end to a width of the exposed end may be between 60 and 100%.

A distance between the first and the second sub-electrodes or a distance between the third and fourth sub-electrodes may be constant.

A distance between the first and second sub-electrodes or a distance between the third and fourth sub-electrodes may be smaller than a distance between the first and third sub-electrodes or a distance between the second and fourth sub-electrodes.

The multi-layered ceramic capacitor may further include first and second external electrodes respectively formed on the first and second surfaces.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a partially cut-away perspective view of a multi-layered ceramic capacitor according to an embodiment of the present invention;

FIG. 2 is an exploded perspective view of the multi-layered ceramic capacitor according to the embodiment of the present invention;

FIGS. 3A and 3B are, respectively, a plan view and a cross-sectional view of the multi-layered ceramic capacitor according to the embodiment of the present invention;

FIGS. 4A and 4B are, respectively, a plan view and a cross-sectional view of a multi-layered ceramic capacitor according to a comparative example;

FIG. 5 is an exploded perspective view of a multi-layered ceramic capacitor according to another embodiment of the present invention; and

FIG. 6 is a plan view of a multi-layered ceramic capacitor according to another embodiment of the present invention.

### DETAILED DESCRIPTION OF THE PREFERRED EMBODIMENT

Hereinafter, embodiments of the present invention will be described in detail with reference to the accompanying drawings.

In describing the present invention below, terms indicating components of the present invention are named in consideration of functions of each component. Therefore, the terms should not be understood as being limited technical components of the present invention.

Rather, these embodiments are provided so that this disclosure will be thorough and complete, and will fully convey the concept of the invention to those skilled in the art. In the drawings, the shapes and dimensions may be exaggerated for clarity, and the same reference numerals will be used throughout to designate the same or like components.

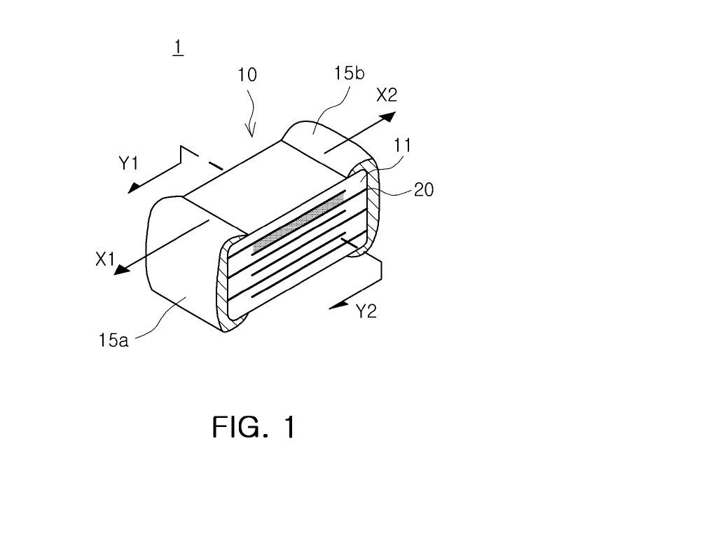

FIG. 1 is a partially cut-away perspective view of a multi-layered ceramic capacitor 1 according to an embodiment of the present invention. Referring to FIG. 1, the multi-layer ceramic capacitor 1 according to the embodiment of the present invention may include a laminated body 10 in which a plurality of dielectric layers 11 are laminated, and first to fourth internal electrodes, 21, 23, 25, and 27 formed between the plurality of dielectric layers 11.

According to the embodiment of the present invention, comb-shaped internal electrodes are formed to reduce the average distance between dielectrics, and to additionally form effective areas, whereby capacitance of the capacitor may be increased. Therefore, a product using the same may have high capacitance while being miniaturized.

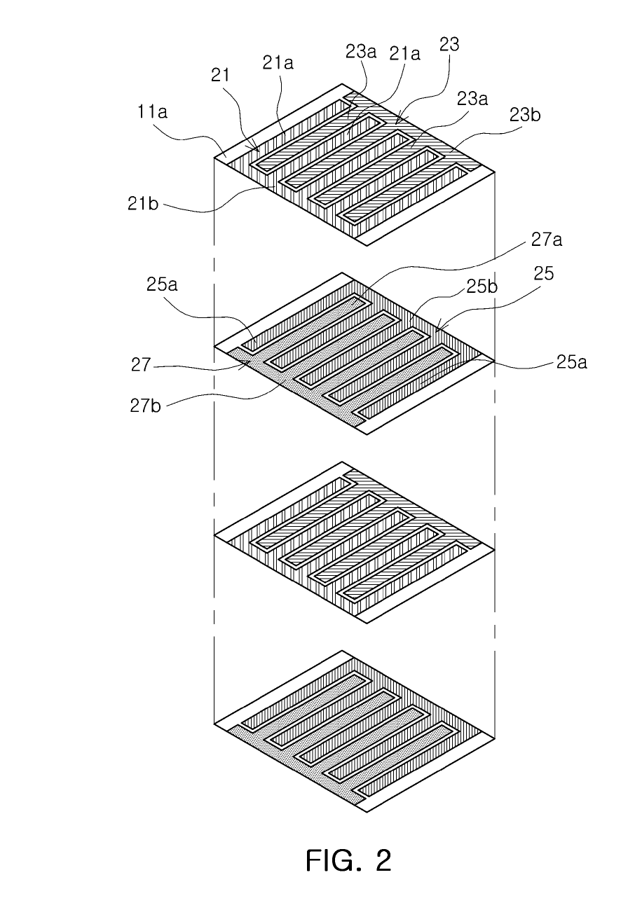

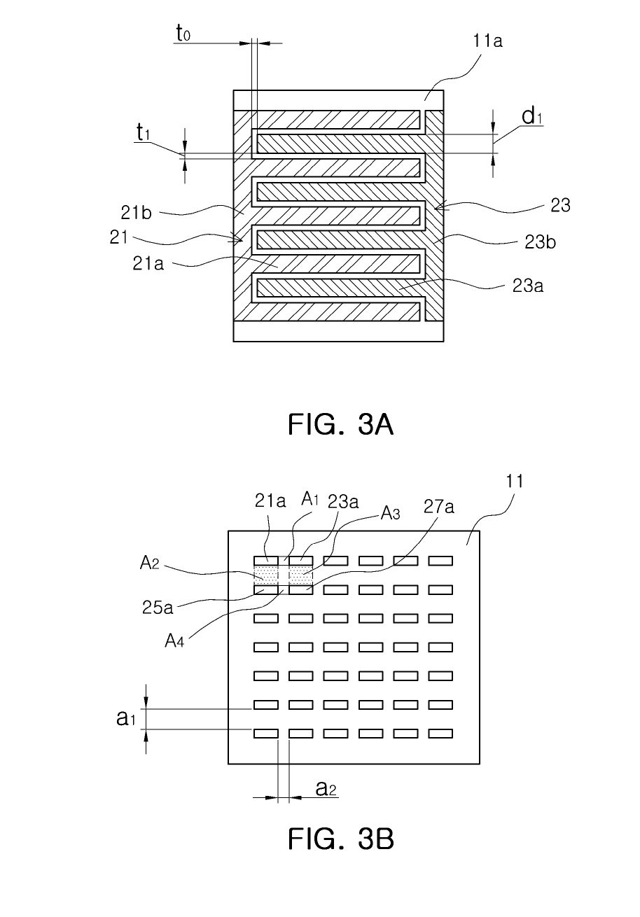

FIG. 2 is an exploded perspective view of the multi-layered ceramic capacitor 1 according to the embodiment of the present invention. FIG. 3A is a plan view of the dielectric layer in which the first and second internal electrodes are formed in the multi-layered ceramic capacitor 1 according to the embodiment of the present invention. FIG. 3B is a cross-sectional view of the multi-layer ceramic capacitor according to the embodiment of the present invention, taken along line Y1-Y2.

Referring to FIG. 2, according to the embodiment of the present invention, the laminated body 10 having the plurality of dielectric layers 11 laminated therein and including first and second surfaces X1 and X2 facing to each other may be formed.

The laminated body 10, which is formed by laminating the plurality of dielectric layers, has a structure in which the plurality of dielectric layers and a plurality of the first and second internal electrodes and the third and fourth internal electrodes formed between the plurality of dielectric layers and exposed to the first and second surfaces X1 and X2 facing each other are alternately laminated.

Referring to FIG. 1, first and second external electrodes 15a and 15b are formed on the first and second surfaces X1 and X2, respectively, such that electricity may be applied to the internal electrodes exposed to the first and second surfaces. The first and second external electrodes may be charged with different polarities to thereby implement capacitance of the capacitor.

The laminated body 10 includes the first to fourth internal electrodes formed therein. According to the embodiment, a structure and an arrangement of the internal electrodes are optimized, whereby a capacitor having a small size and high capacitance may be implemented.

Referring to FIGS. 2 and 3, according to the embodiment of the present invention, the first internal electrode 21 exposed to the first surface and including a plurality of first sub-electrodes 21a is formed between the plurality of dielectric layers 11.

The first internal electrode 21 may be disposed in any one of the plurality of dielectric layers 11 and include the plurality of first sub-electrodes 21a and a lead part 21b connecting the plurality of first sub-electrodes 21a to each other.

The plurality of first sub-electrodes 21a may have a bar shape and may be spaced apart from each other by a predetermined distance. In addition, the plurality of first sub-electrodes 21a may be connected to each other by the lead part 21b to thereby be exposed to the first surface X1.

According to the embodiment of the present invention, the plurality of first sub-electrodes 21a and the lead part 21b may be connected to thereby have a comb shape.

The second internal electrode 23 including a plurality of second sub-electrodes 23a disposed to be engaged with the first sub-electrodes 21a may be formed in the dielectric layer in which the first internal electrode 21 is formed.

The second internal electrode 23 may include the plurality of second sub-electrodes 23a and a lead part 23b to thereby have a comb shape, similarly to the first internal electrode 21.

According to the embodiment of the present invention, the first and second internal electrodes may be formed in such a manner that the plurality of first sub-electrodes and the plurality of second sub-electrodes may be engaged with each other. Therefore, an area in which the first and second sub-electrodes are opposed to each other may become an active area to thereby allow for the implementation of capacitance.

The third internal electrode 25 having at least one dielectric layer 11 disposed between the first and second internal electrodes and the third internal electrode, exposed to the second surface, and including a plurality of third sub-electrodes 25a disposed to be opposed to the first sub-electrodes 21a may be formed.

The third internal electrode 25 may include the plurality of third sub-electrodes 25a and a lead part 25b connecting the plurality of third sub-electrodes 25a. The third internal electrode 25 may have a comb shape, similarly to the first and second internal electrodes.

The third internal electrode 25 may be exposed to the second surface and connected to the external electrode to which the second internal electrode is connected. In addition, the third sub-electrodes 25a of the third internal electrode 25 may be opposed to the plurality of first sub-electrodes 21a of the first internal electrode, while having at least one dielectric layer therebetween.

Therefore, the plurality of first sub-electrodes 21a and the plurality of third sub-electrode 25a may be charged with different polarities to form an active area, thereby allowing for the implementation of capacitance.

The fourth internal electrode 27 may also be formed in the dielectric layer in which the third internal electrode is formed. The fourth internal electrode 27 may be exposed to the first surface X1 and include a plurality of fourth sub-electrodes 27a opposed to the second sub-electrodes 23a and disposed to be engaged with the third sub-electrodes 25a.

The fourth internal electrode 27 may include the plurality of fourth sub-electrodes 27a and a lead part 27b connecting the plurality of fourth sub-electrodes 27a. Therefore, the fourth internal electrode 27 may have a comb shape, similarly to the first to third internal electrodes.

In addition, the plurality of third sub-electrodes 25a of the third internal electrode and the plurality of fourth sub-electrodes 27a of the fourth internal electrode may be engaged with each other. Therefore, the plurality of third sub-electrodes of the third internal electrode and the plurality of fourth sub-electrodes of the fourth internal electrode that are exposed in different directions and charged with different polarities maybe engaged with each other to have an effective area, thereby allowing for the implementation of capacitance.

The fourth internal electrode 27 may be exposed to the same first surface to which the first internal electrode 21 is exposed and be connected to the same external electrode to which the first internal electrode 21 is connected. The plurality of fourth sub-electrodes 27a of the fourth internal electrode may be opposed to the plurality of second sub-electrode 23a, while having at least one dielectric layer therebetween.

Therefore, the plurality of second sub-electrodes 23a of the second internal electrode and the plurality of fourth sub-electrodes 27a of the fourth internal electrode may be charged with different polarities to have effective areas, thereby allowing for the implementation of capacitance.

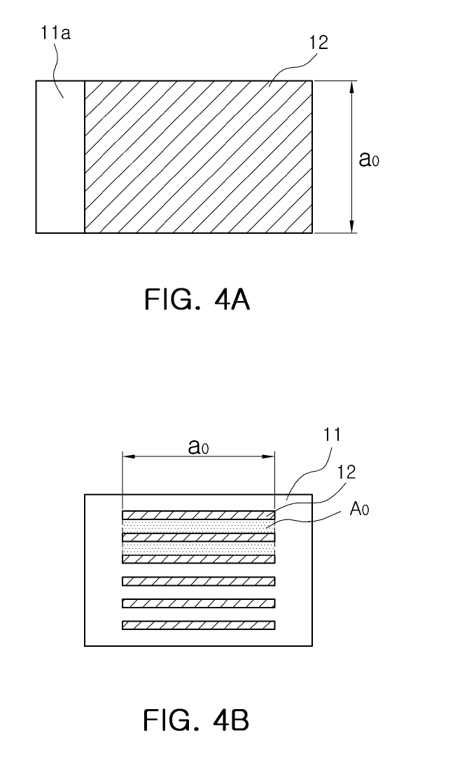

FIG. 4A is a view showing flat panel shaped internal electrodes of a multi-layered ceramic capacitor according to a comparative example. The flat panel shaped internal electrodes 12 may be exposed in different directions, in the plurality of dielectric layers 11.

Referring to FIG. 4B, according to the comparative example, the internal electrodes 12 exposed in different directions may be alternately laminated. Therefore, the internal electrodes 12 exposed in different directions and having different polarities maybe opposed to each other within the laminated body 10.

Accordingly, the internal electrodes 12 that are adjacent to each other and have different polarities may have a single effective area A₀ therebetween. The capacitance of this capacitor may be represented by the following Equation.

$${C}_{0} = \frac{{ɛ}_{0} {A}_{0} ( n - 1 )}{d}$$

The capacitance C₀ of the flat panel shaped multi-layered ceramic capacitor may be determined by an effective area A₀ between internal electrodes having different permittivity ∈_{O} and charged with different polarities and a distance d between the internal electrodes. In addition, the capacitance of the flat panel shaped multi-layered ceramic capacitor has a value propotional to the number n of laminated internal electrodes.

Particularly, the effective area A₀ of the flat panel shaped multi-layered ceramic capacitor is determined by an opposing area between the internal electrodes disposed to have at least one dielectric layer therebetween. Referring to FIG. 4B, the effective area may be determined by multiplication between a length a₀ of an internal electrode pattern and a length of an overlapped area between the internal electrodes.

According to the embodiment of the present invention, any one sub-electrode selected from a group consisting of the first to fourth sub-electrodes may include one active area defined in relation to a sub-electrode disposed to be opposed to any one sub-electrode, while having the dielectric layer therebetween, and another active area defined in relation to a sub-electrode disposed to be engaged with any one sub-electrode.

Unlike the multi-layered ceramic capacitor including the flat panel shaped internal electrodes, the multi-layered ceramic capacitor including the comb shaped internal electrodes may include one active area formed by sub-electrodes formed in different layers and disposed to be opposed to each other, while having the dielectric layer therebetween, and another active area formed by sub-electrodes alternately disposed in the same dielectric layer.

Therefore, the multi-layered ceramic capacitor according to the embodiment of the present invention may further include the active area formed by the sub-electrodes alternately disposed in the same dielectric layer and charged with different polarities, whereby the effective area of the multi-layered ceramic capacitor may be further increased.

Referring to FIG. 3B, the multi-layered ceramic capacitor according to the embodiment of the present invention may include a first active area A₁, a second active area A₂, a third active area A₃, and a fourth active area A₄.

The first active area A₁ may be formed by disposing the first and second sub-electrodes 21a and 23a so as to be engaged with each other, and the second active area A₂ may be formed by disposing the first and third sub-electrodes 21a and 25a so as to be opposed to each other, while having at least one dielectric layer therebetween.

In addition, the third active area A₃ is an area in which capacitance is implemented by disposing the second and fourth sub-electrodes 23a and 27a so as to be opposed to each other, and the fourth active area A₄ is an area in which capacitance is implemented by disposing the third and fourth sub-electrodes 25a and 27a so as to be engaged with each other.

The second and third active areas A₂ and A₃ are vertical active areas formed by the internal electrodes disposed in a vertical direction. The first and fourth active areas A₁ and A₄ are horizontal active areas formed by the sub-electrodes disposed in a horizontal direction.

The internal electrodes according to the embodiment of the present invention are formed to have the active areas in both of vertical and horizontal directions, whereby larger capacitance may be implemented.

In the case of the internal electrodes according to the embodiment of the present invention, the capacitance may be represented by the following Equation.

$${C}_{1} + {C}_{2} = \text{?} + \text{?}$$

$$\text{?} \text{indicates text missing or illegible when filed}$$

The capacitance C₁ due to the vertical active areas and the capacitance C₂ due to the horizontal active areas are summed up to form the total capacitance.

Referring to FIGS. 3A and 3B, the capacitance C₁ due to the vertical active areas is determined by an area A_{2,3} of the second and third active areas A₂ and A₃ and the distance d between the internal electrodes. According to the embodiment of the present invention, the distance d between the internal electrodes may be defined as a distance a₁ between the first and third internal electrodes or a distance a₁ between the second and fourth internal electrodes.

In addition, the capacitance C₂ due to the horizontal active areas is proportional to an area A_{1,4} of the first and fourth active areas A₁ and A₄, and a distance do between the internal electrodes may be defined as a distance a₂ between the first and second sub-electrodes or a distance a₂ between the third and fourth sub-electrodes.

Referring to FIG. 3A showing the first and second internal electrodes according to the embodiment of the present invention, the first and second internal electrodes may have the plurality of first and second sub-electrodes 21a and 23a, respectively and have a rectangular shape.

In this case, since the first and second internal electrodes have a rectangular shape, a distance t₀ and t₁ between the first and second sub-electrodes 21a and 23a may have a constant value in all directions.

Particularly, in the capacitance C₂ due to the horizontal active areas, the distance a₂ between the first and second sub-electrodes may be determined according to the distance t₀ and t₁ between the first and second sub-electrodes 21a and 23a. Therefore, the distance t₀ and t₁ between the first and second sub-electrodes 21a and 23a may be adjusted to thereby control the capacitance.

In addition, the capacitance of the capacitor may be adjusted by the distance do between the internal electrodes charged with different polarities and disposed to have at least one dielectric layer therebetween.

More specifically, the capacitance of the capacitor may be adjusted by the distance a₁ between the first and third internal electrodes and the distance a₁ between the second and fourth internal electrodes.

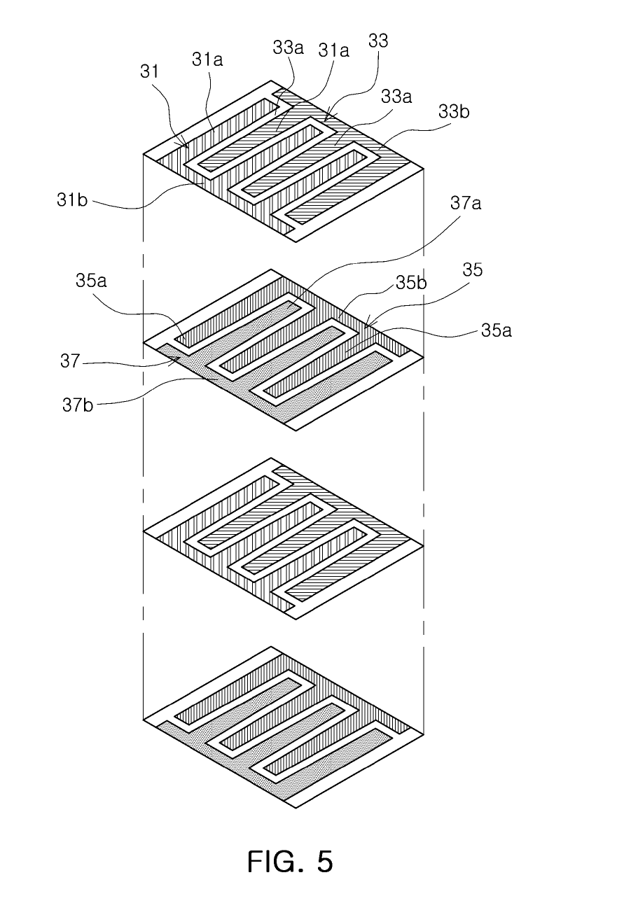

FIG. 5 shows a multi-layered ceramic capacitor according to another embodiment of the present invention. The multi-layered ceramic capacitor according to another embodiment of the present invention may include trapezoidal shaped sub-electrodes in order to decrease equivalent series resistance (ESR) of electrodes while increasing capacitance.

Referring to FIG. 5, the multi-layered ceramic capacitor may include first and second internal electrodes 31 and 33 formed in the same dielectric layer and having a comb shape, and third and fourth internal electrodes 35 and 37 formed to have at least one dielectric layer disposed between the first and second internal electrodes 31 and 33 and the third and fourth internal electrodes 35 and 37 and having a comb shape.

In addition, the first to fourth internal electrodes 31, 33, 35, and 37 may include a plurality of first to fourth sub-electrodes 31a, 33a, 35a, and 37a, respectively, and lead parts 31b, 33b, 35b, and 37b, respectively, the first to fourth sub-electrodes forming a plurality of comb shapes and the lead parts connecting the plurality of first to fourth sub-electrodes 31a, 33a, 35a, and 37a to each other.

The plurality of first sub-electrodes 31a may have a bar shape and may be spaced apart from each other by a predetermined distance. In addition, the plurality of first sub-electrodes 31a may be connected to each other by the lead part 31b and exposed to the first surface X1.

According to the embodiment of the present invention, the plurality of first sub-electrodes 31a and the lead part 31b may be connected to have a comb shape.

The second internal electrode 33 including the plurality of second sub-electrodes 33a disposed to be engaged with the first sub-electrodes 31a may be formed in the dielectric layer in which the first internal electrode 31 is formed.

The second internal electrode 33 may include the plurality of second sub-electrodes 33a and the lead part 33b and have a comb shape, similarly to the first internal electrode 31.

According to the embodiment of the present invention, the first and second internal electrodes may be formed such that the plurality of first sub-electrodes and the plurality of second sub-electrodes are engaged with each other. Therefore, an area in which the first and second sub-electrodes are opposed to each other may become an active area to thereby allow for the implementation of capacitance.

The third internal electrode 35 having at least one dielectric layer 11 disposed between the first and second internal electrodes 31 and 33 and the third internal electrode 35, exposed to the second surface, and including the plurality of third sub-electrodes 35a disposed to be opposed to the first sub-electrodes 31a may be formed.

The third internal electrode 35 may include the plurality of third sub-electrodes 35a and the lead part 35b connecting the plurality of third sub-electrodes 35a to each other. The third internal electrode 35 may have a comb shape, similarly to the first and second internal electrodes.

The third internal electrode 35 may be exposed to the second surface and connected to the same external electrode to which the second internal electrode 33 is connected. In addition, the third sub-electrodes 35a of the third internal electrode 35 and the plurality of first sub-electrodes 31a of the first internal electrode 31 may be opposed to each other, while having at least one dielectric layer therebetween.

Therefore, the plurality of first sub-electrodes 31a and the plurality of third sub-electrode 35a may be charged with different polarities to form an active area, thereby allowing for the implementation of capacitance.

In addition, the fourth internal electrode 37 may be formed in the same dielectric layer in which the third internal electrode 35 is formed. The fourth internal electrode 37 may be exposed to the first surface X1 and include a plurality of fourth sub-electrodes 37a opposed to the second sub-electrodes 33a and alternately disposed with the third sub-electrodes 35a.

The fourth internal electrode 37 may include the plurality of fourth sub-electrodes 37a and the lead part 37b connecting the plurality of fourth sub-electrodes 37a to each other. Therefore, the fourth internal electrode 37 may have a comb shape, similarly to the first to third internal electrodes.

In addition, the plurality of third sub-electrodes 35a of the third internal electrode 35 and the plurality of fourth sub-electrodes 37a of the fourth internal electrode 37 may be engaged with each other. Therefore, the plurality of third sub-electrodes 35a of the third internal electrode 35 and the plurality of fourth sub-electrodes 37a of the fourth internal electrode 37 that are exposed in different directions and charged with different polarities maybe engaged with each other to have an effective area, thereby allowing for the implementation of capacitance.

The fourth internal electrode 37 may be exposed to the same first surface to which the first internal electrode 31 is exposed and be connected to the same external electrode to which the first internal electrode 31 is connected. The plurality of fourth sub-electrodes 37a of the fourth internal electrode 37 may be opposed to the plurality of second sub-electrode 33a of the second internal electrode 33, while having at least one dielectric layer therebetween.

Therefore, the plurality of second sub-electrodes 33a of the second internal electrode 33 and the plurality of fourth sub-electrodes 37a of the fourth internal electrode 37 may be charged with different polarities to have an effective area, thereby allowing for the implementation of capacitance.

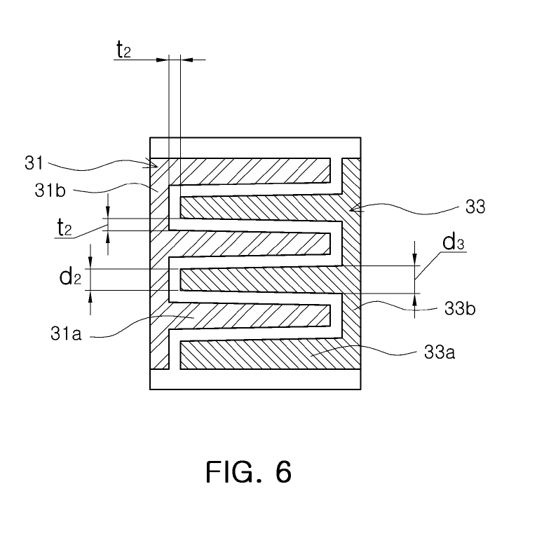

Referring to FIG. 6, at least one sub-electrode selected from a group consisting of the first to fourth sub-electrodes 31a, 33a, 35a, and 37a may include a free end and an exposed end and have a trapezoidal shape in which the free end has a width d₂ equal to or smaller than a width d₃ of the exposed end.

In addition, the first and second sub-electrodes 31a and 33a may have a constant distance t₂ therebetween.

When it is assumed that each of capacitance and a resistance value of the multi-layered ceramic capacitor including the internal electrodes according to the comparative example shown in FIG. 4 is 1, capacitance and a resistance value of the multi-layered ceramic capacitor including the rectangular shaped sub-electrodes according to the embodiment of the present invention shown in FIG. 3 maybe 1.117 and 1.208, respectively, and capacitance and a resistance value of the multi-layered ceramic capacitor having the trapezoidal shaped sub-electrodes shown in FIG. 5 may be 1.04 and 1.088, respectively.

The multi-layered ceramic capacitor including the trapezoidal shaped sub-electrodes may have a decreased capacitance value as compared to the case of the multi-layered ceramic capacitor having the rectangular shaped sub-electrodes; however, has a decreased electrode resistance component as compared to the case of the multi-layered ceramic capacitor having the rectangular shaped sub-electrodes, whereby ESR characteristics may be improved. This is because that when the sub-electrodes charged with different polarities are formed in the same dielectric layer, the entire ESR may be decreased due to offset effect of resistance.

Therefore, the ESR is decreased while the capacitance is increased, whereby the multi-layered ceramic capacitor having a high Q-value may be implemented.

According to the embodiment of the present invention, the multi-layered ceramic capacitor in which a ratio of a width of the free end to a width of the exposed end may be between 60 and 100% may be implemented. When the width of the free end is below 60% of the width of the exposed end, an area thereof configuring the active area is reduced, such that capacitance may be excessively reduced. Therefore, the width of the free end may be more than 60% of the width of the exposed end.

In addition, the distance between the first and the second sub-electrodes 31a and 33a formed in the same dielectric layer or the distance between the third and fourth sub-electrodes 35a and 37a formed in the same dielectric layer may be constant. This is because that as the distance between the sub-electrodes is uniform and reduced, the capacitance may be further increased and the resistance may be further decreased.

According to the embodiment of the present invention, the distance between the first and second sub-electrodes or the distance between the third and fourth sub-electrodes may be smaller than the distance between the first and third sub-electrodes or the distance between the second and fourth sub-electrodes. Since the distance between sub-electrodes adjacent to each other in the same dielectric layer is smaller than the distance between upper and lower sub-electrodes, capacitance secured in the same area may be increased and an area occupied by the sub-electrodes may be minimized.

As set forth above, according to embodiments of the present invention, the multi-layered ceramic capacitor having a minimized size while having maximized capacitance by optimizing a structure thereof could be provided.

According to embodiments of the present invention, the multi-layered ceramic capacitor capable of optimizing a Q value by decreasing an ESR value of the capacitor through a minimization of a resistance value of the internal electrode, while increasing capacitance, could be provided.

Therefore, the multi-layered ceramic capacitor having excellent electrical characteristics while implementing miniaturization and high capacitance could be provided.

While the present invention has been shown and described in connection with the embodiments, it will be apparent to those skilled in the art that modifications and variations can be made without departing from the spirit and scope of the invention as defined by the appended claims.

What is claimed is:

1. A multi-layered ceramic capacitor comprising:
a laminated body having a plurality of dielectric layers laminated therein and including first and second surfaces opposed to each other;
a first internal electrode formed between the plurality of dielectric layers, exposed to the first surface, and including a plurality of first sub-electrodes;
a second internal electrode exposed to the second surface and including a plurality of second sub-electrodes alternately disposed with the first sub-electrodes;
a third internal electrode having at least one dielectric layer disposed between the first and second internal electrodes and the third internal electrode, exposed to the second surface, and including a plurality of third sub-electrodes disposed to be opposed to the first sub-electrodes; and
a fourth internal electrode exposed to the first surface and including a plurality of fourth sub-electrodes opposed to the second sub-electrodes and alternately disposed with the third sub-electrodes.

2. The multi-layered ceramic capacitor of claim 1, wherein the first and second internal electrodes or the third and fourth internal electrodes have a comb shape and are disposed to be engaged with each other within the same dielectric layer.

3. The multi-layered ceramic capacitor of claim 1, wherein any one sub-electrode selected from a group consisting of the first to fourth sub-electrodes includes:
one active area defined in relation to a sub-electrode disposed to be opposed to any one sub-electrode, while having the at least one dielectric layer therebetween; and
another active area defined in relation to a sub-electrode disposed to be engaged with any one sub-electrode.

4. The multi-layered ceramic capacitor of claim 1, wherein the first and second internal electrodes include:
a first active area formed between the first and second sub-electrodes;
a second active area formed between the first and third sub-electrodes;
a third active area formed between the second and fourth sub-electrodes; and
a fourth active area formed between the third and fourth sub-electrodes.

5. The multi-layered ceramic capacitor of claim 1, wherein each of the plurality of the first, second, third, fourth sub-electrodes is connected to each other by a single lead part and exposed to the first or second surface.

6. The multi-layered ceramic capacitor of claim 1, wherein each of the first, second, third, fourth sub-electrodes has a rectangular shape.

7. The multi-layered ceramic capacitor of claim 1, wherein each of the first, second, third, fourth sub-electrodes has a trapezoidal shape.

8. The multi-layered ceramic capacitor of claim 1, wherein a distance between the first and third internal electrodes formed in different layers, or a distance between the second and fourth internal electrodes formed in different layers, is adjusted to thereby adjust capacitance.

9. The multi-layered ceramic capacitor of claim 1, wherein a distance between the first and second sub-electrodes formed in the same dielectric layer or a distance between the third and fourth sub-electrodes formed in the same dielectric layer is adjusted to thereby adjust capacitance.

10. The multi-layered ceramic capacitor of claim 1, wherein at least one sub-electrode selected from a group consisting of the first to fourth sub-electrodes includes a free end and an exposed end, and
a ratio of a width of the free end to a width of the exposed end is between 60 and 100%.

11. The multi-layered ceramic capacitor of claim 1, wherein a distance between the first and the second sub-electrodes or a distance between the third and fourth sub-electrodes is constant.

12. The multi-layered ceramic capacitor of claim 1, wherein a distance between the first and second sub-electrodes or a distance between the third and fourth sub-electrodes is smaller than a distance between the first and third sub-electrodes or a distance between the second and fourth sub-electrodes.

13. The multi-layered ceramic capacitor of claim 1, further comprising first and second external electrodes respectively formed on the first and second surfaces.
